(19) United States
(12) Patent Application Publication
(10) Pub. No.: US 2026/0316971 A1
(43) Pub. Date: Oct. 15, 2026

(54) MULTICOPTER, FIXING MECHANISM, AND METHOD

(71) Applicant: MITSUBISHI HEAVY INDUSTRIES, LTD., Tokyo (JP)

(72) Inventor: Yosuke SAKAI, Tokyo (JP)

(21) Appl. No.: 19/359,694

(22) Filed: Oct. 16, 2025

(30) Foreign Application Priority Data
Apr. 10, 2025 (JP) 2025-064799

(51) Int. Cl. B64U 30/293; B64U 10/14; B64U 20/50

(52) U.S. Cl. CPC B64U 30/293; B64U 10/14; B64U 20/50

(57) ABSTRACT

A multicopter includes: first and second links, one of which is pivotable relative to the other between an open position and a closed position about a pin joint; and a slider crank mechanism holding the first and second links at the closed position. The slider crank mechanism includes a follower reciprocable between a fixing position at which the first and second links are holdable at the closed position and a releasing position at which the first and second links are releasable from the closed position by forward or reverse rotation of a rotor shaft, a driver pivoted by the forward or reverse rotation of the rotor shaft, a coupler rotatably coupled to the follower and rotatably coupled to the driver, and a fixed link rotatably coupled to the driver and slidably coupled to the follower. The follower held at the fixing position locks the first and second links.

### CROSS-REFERENCE TO RELATED APPLICATIONS

This application claims the benefit of priority to Japanese Patent Application Number 2025-064799 filed on Apr. 10, 2025. The entire contents of the above-identified application are hereby incorporated by reference.

### TECHNICAL FIELD

The disclosure relates to a fixing mechanism for arms of a multicopter and a method for fixing or releasing the same.

### RELATED ART

Application of a multicopter capable of vertical takeoff and landing as a substitute for a manned helicopter has been studied. A typical multicopter has three or more arms, and the dimension in the horizontal direction of the multicopter increases when the arms are unfolded for the flight of the multicopter itself. On the other hand, when the multicopter is transported by a transport vehicle or the like or housed, the arms need to be folded to decrease the horizontal dimension and reduce the occupied space.

For example, a known method is making the arms foldable with hinges and in unfolding the arms, rotating the arms about the hinges and then fixing the arms with bolts and nuts. However, the fixing method using bolts and nuts needs two workers, a worker who holds the positions of the arms after the arms are unfolded and a worker who attaches the bolts and nuts and needs to check the number, type, and the like of the bolts and nuts before and after the fixing work. In order to reduce a load in checking parts such as bolts and nuts that are attached to and detached from a flying object before and after the fixing work on the flying object, there are preferably no parts to be attached to and detached from the flying object. Reduction of a work load in work of fixing the arms has been awaited.

EP 4122820 A discloses a landing device assembly for an aircraft in which a pin reciprocating inside a horizontal tubular structure is projected from the horizontal tubular structure to engage with a connection point provided on the lower side of the aircraft, or is retracted into the horizontal tubular structure to release the engagement with the connection point.

### SUMMARY

In view of the above, an object of the disclosure is to provide a multicopter capable of fixing or releasing an arm with a single action.

A multicopter according to the disclosure includes: a first link and a second link, one of the first link and the second link being pivotable relative to the other of the first link and the second link between an open position and a closed position about a pin joint; and a fixing mechanism configured to hold the first link and the second link at the closed position. The fixing mechanism is a slider crank mechanism and includes a follower that can be reciprocated between a fixing position at which the first link and the second link can be held at the closed position and a releasing position at which the first link and the second link can be released from the closed position by forward rotation or reverse rotation of a rotor shaft, a driver pivoted by the forward rotation or the reverse rotation of the rotor shaft, a coupler rotatably coupled to the follower and rotatably coupled to the driver, and a fixed link rotatably coupled to the driver and slidably coupled to the follower. The follower held at the fixing position locks the first link and the second link.

A fixing mechanism according to the disclosure is a fixing mechanism for holding a tip end-side arm attached to a base end-side arm connected to a fuselage of a multicopter at an unfolded position. The fixing mechanism includes: a follower that can be reciprocated between a fixing position and a releasing position by forward rotation or reverse rotation of a rotor shaft; a driver pivoted by the forward rotation or the reverse rotation of the rotor shaft; a coupler rotatably coupled to the follower and rotatably coupled to the driver; and a fixed link rotatably coupled to the driver and slidably coupled to the follower. The follower held at the fixing position locks the base end-side arm and the tip end-side arm.

A method according to the disclosure is a method for fixing a tip end-side arm pin-joined to a base end-side arm connected to a fuselage of a multicopter and provided with a rotor at an unfolded position at which the tip end-side arm is unfolded and the multicopter is flyable or for releasing the tip end-side arm from the unfolded position. The method includes: by applying a rotational force in one direction of a forward rotation or a reverse rotation to a fixing mechanism as a slider crank mechanism after the tip end-side arm reaches the unfolded position, causing a follower of the fixing mechanism to linearly move toward one side and causing the base end-side arm and the tip end-side arm to be locked to the follower; or by applying a rotational force in the other direction of the forward rotation or the reverse rotation to the fixing mechanism, causing the follower of the fixing mechanism to linearly move toward the other side and releasing a locked state by the follower.

The disclosure can provide a multicopter capable of fixing or releasing an arm with a single action of forward rotation or reverse rotation of a rotor shaft.

### BRIEF DESCRIPTION OF DRAWINGS

The disclosure will be described with reference to the accompanying drawings, wherein like numbers reference like elements.

FIG. 1 is a diagram illustrating an outline of a multicopter according to an embodiment of the disclosure, where (FO) illustrates a form in which arms are folded, and (DE) illustrates a form in which the arms are unfolded.

FIG. 2 is a diagram illustrating an outline of a folding mechanism of an arm according to the embodiment of the disclosure, where (FO) is an enlarged view of a form in which the arm is folded, and (DE) is an enlarged view of a form in which the arm is unfolded.

FIG. 3 is a diagram illustrating a releasing position of a fixing mechanism according to the embodiment of the disclosure.

FIG. 4 is a diagram illustrating a halfway position of the fixing mechanism according to an embodiment of the disclosure operating between a fixing position and a releasing position.

FIG. 5 is a diagram illustrating the fixing position of the fixing mechanism in a form in which the arms according to the embodiment of the disclosure are unfolded and fixed.

### DESCRIPTION OF EMBODIMENTS

Hereinafter, embodiments will be described with reference to the attached drawings.

According to a fixing mechanism of a folding mechanism 30 of arms 20 of a multicopter 1 of the present embodiment, the arms 20 can be fixed or released by a single action.

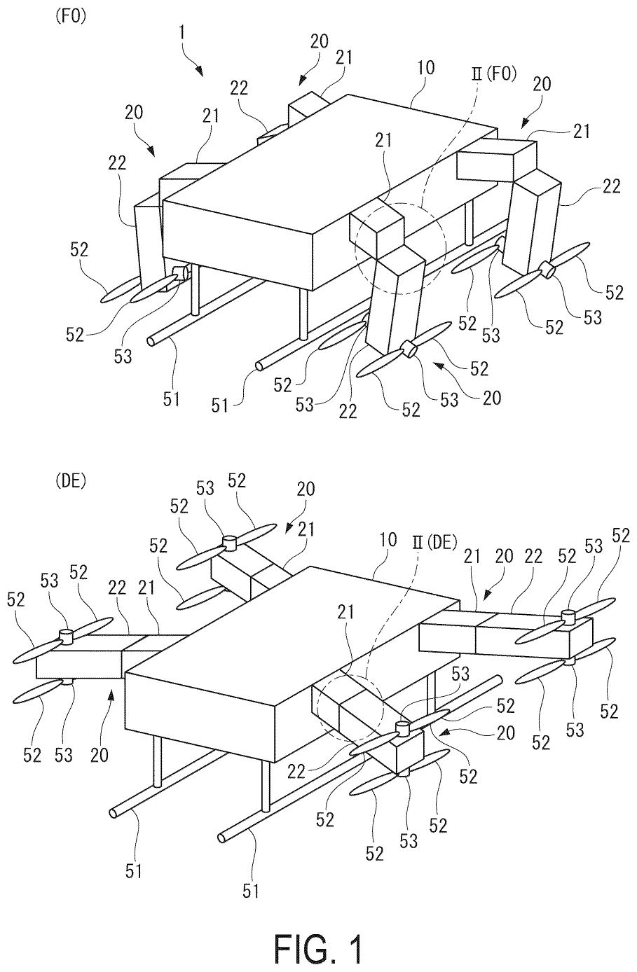

### Multicopter 1: see FIG. 1

In the multicopter 1, the arms 20 can be folded or unfolded.

As illustrated in FIG. 1, the multicopter 1 includes a fuselage 10, four arms 20 extending in a horizontal direction from the fuselage 10 and capable of being unfolded or folded, and two skids 51 connected to the fuselage 10 and coming into contact with the ground when the multicopter 1 is in a takeoff and landing attitude.

The arm 20 includes a base end-side arm 21 connected to the fuselage 10 and a tip end-side arm 22 provided with a rotor 53. The tip end-side arm 22 is provided with two rotor sets each including a rotor 53 and two blades 52 attached to the rotor 53 and rotated by the rotor 53. The multicopter 1 can fly by the blades 52 being rotated by the rotor 53. The description of the operation of the blades 52 and the rotors 53 for the flight of the multicopter 1 is omitted.

(FO) of FIG. 1 illustrates a form in which the four arms 20 of the multicopter 1 are folded. Each of the tip end-side arms 22 of the arms 20 in the folded form is bent downward about a pin joint.

(DE) of FIG. 1 illustrates a form in which the tip end-side arms 22 of the four arms 20 of the multicopter 1 are unfolded, and the multicopter 1 can take off and land and can fly.

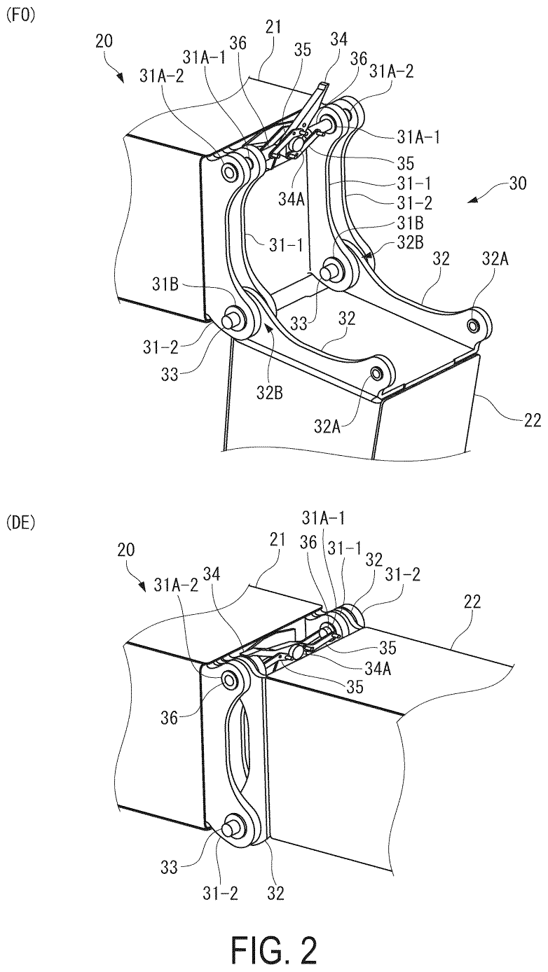

### Arm 20 and Folding Mechanism 30: See FIG. 2

The arm 20 is configured such that the tip end-side arm 22 is foldable about a pin joint provided at the base end-side arm 21 connected to the fuselage 10.

As illustrated in FIG. 2, the arm 20 includes a folding mechanism 30 in which the base end-side arm 21 connected to the fuselage 10 and the tip end-side arm 22 provided with the rotors 53 are coupled, and the tip end-side arm 22 can be displaced to an unfolded position or a folded position about a hinge. The unfolded position constitutes a closed position of the disclosure, and the folded position constitutes an open position of the disclosure.

The folding mechanism 30 includes four clevises 31 provided at the base end-side arm 21, a handle 34 pivotable about a rotor shaft 34A, two links 35 attached to the handle 34, and two pins 36 attached to each of the links 35. Two clevises 31-1 and 31-2 are arranged side by side on one side in the base end-side arm 21, and two clevises 31-1 and 31-2 are arranged side by side on the other side. The links 35 and the pins 36 are provided symmetrically with respect to the rotor shaft 34A.

The folding mechanism 30 further includes lugs 32 provided at the tip end-side arm 22, and hinge pins 33 that rotatably connect the clevises 31-1 and 31-2 and the lugs 32. The hinge pins 33 form a pin joint between the clevises 31-1 and 31-2 as a first link and the lugs 32 as a second link.

The clevises 31-1 and 31-2 are provided with bushings 31A-1 and 31A-2 into which the pins 36 are inserted, and hinge bushings 31B into which the hinge pins 33 are inserted.

The lugs 32 are provided with bushings 32A into which the pins 36 are inserted, and hinge bushings 32B into which the hinge pins 33 are inserted.

The hinge bushings 31B of the clevises 31, the hinge bushings 32B of the lugs 32, and the hinge pins 33 form a pin joint. The folding mechanism 30 will be described in detail below.

(FO) of FIG. 2 illustrates a form in which the tip end-side arm 22 is folded. The base end-side arm 21 supported by the fuselage 10 in a cantilever manner and the tip end-side arm 22 are rotatably coupled by the hinge pins 33. The tip end-side arm 22 pivots downward by the gravity about the hinge pins 33, and the folded form of the tip end-side arm 22 is maintained.

At this time, the pins 36 are not pulled out from the bushings 31A-1 of the inner clevises 31-1 closer to the rotor shaft 34A, but are pulled out from the bushings 31A-2 of the outer clevises 31-2 farther from the rotor shaft 34A and the bushings 32A of the lugs 32. The inner clevises 31-1 and the outer clevises 31-2 constitute a first A link and a first B link of the disclosure.

(DE) of FIG. 2 illustrates a form in the unfolded position in which the tip end-side arm 22 is unfolded. After the tip end-side arm 22 is flipped upward about the hinge pins 33 and displaced to the unfolded position, the pins 36 are inserted into the bushings 31A-1 and 31A-2 of all the clevises 31-1 and 31-2 and the bushings 32A of the lugs 32, and the clevises 31 and the lugs 32 are locked by the pins 36. The pins 36 lock the clevises 31 provided at the base end-side arm 21 and the lugs 32 provided at the tip end-side arm 22, thereby holding the tip end-side arm 22 at the unfolded position. The lugs 32 are arranged, together with the inner clevises 31-1 and the outer clevises 31-2, along a direction in which the center axis of rotation of the hinge pins 33 extends, and each of the lugs is sandwiched between the inner clevis 31-1 and the outer clevis 31-2.

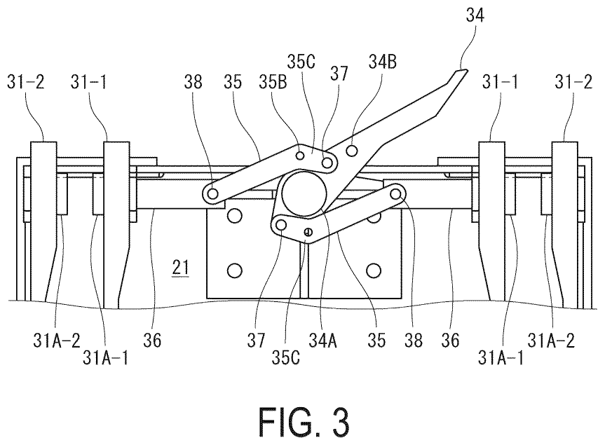

### Folding Mechanism 30: See FIGS. 3, 4, and 5

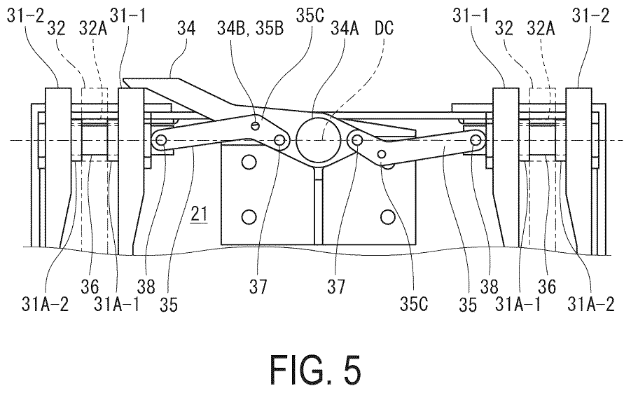

As illustrated in FIG. 3, the handle 34 of the folding mechanism 30 is provided with a lock hole 34B into which a lock pin (not illustrated) can be inserted when the lock hole 34B overlaps with a lock hole 35B provided at the link 35 in the front view of the base end-side arm 21 (see FIG. 5). The handle 34 is rotatably coupled with the link 35 by a first joint 37. The rotor shaft 34A that rotationally moves along with the pivoting movement of the handle 34 is rotatably supported by the base end-side arm 21. The handle 34 is provided with a lever portion extending in the radial direction about the rotor shaft 34A that can be gripped by an operator.

The link 35 is provided with the lock hole 35B, the lock pin is inserted into the lock hole 35B together with the lock hole 34B. The link 35 is rotatably coupled to the handle 34 by the first joint 37 at one side and is rotatably coupled to the pin 36 by a second joint 38 at the other side.

In a front view of the base end-side arm 21, the link 35 is provided with a bent portion 35C. In a releasing operation of the handle 34, the bent portion 35C of the link 35 can avoid the rotor shaft 34A, allowing the movement distance of the pin 36 to be increased as compared with a link formed in a linear shape.

The handle 34 moves to a 1 o'clock position beyond a 12 o'clock position of the rotor shaft 34A, and thus the handle 34 is held at the releasing position due to the gravity until an external force in a counterclockwise direction is applied to the handle 34. It is assumed that the rotor shaft 34A rotates in a forward direction when the handle 34 is pivoted clockwise, and the rotor shaft 34A rotates in a reverse direction when the handle 34 is pivoted counterclockwise.

The pin 36 is rotatably coupled to the link 35 by the second joint 38. The pin 36 is also slidably coupled to the bushing 31A-1 of the inner clevis 31-1 and can be reciprocated. The bushing 31A-1 of the inner clevis 31-1 couples the base end-side arm 21 and the pin 36 to make them function as a prismatic pair. The pin 36 can linearly reciprocate along a direction in which the center axis of rotation of the hinge pin 33 extends.

The link mechanism of the base end-side arm 21, the handle 34, the links 35, and the pins 36 can be regarded as a slider crank mechanism that converts the rotational movement of the rotor shaft 34A of the handle 34 into the reciprocating linear movement of the pins 36. The handle 34 as a driver and the links 35 as couplers are rotatably coupled by the first joints 37 functioning as a revolute pair. The links 35 as couplers and the pins 36 as followers are rotatably coupled by the second joints 38 functioning as a revolute pair. The base end-side arm 21 as a fixed link and the handle 34 as a driver are rotatably coupled by the rotor shaft 34A functioning as a revolute pair. The pins 36 as followers and the base end-side arm 21 as a fixed link are coupled so as to be capable of reciprocating linear movement by the bushings 31A-1 of the inner clevises 31-1 functioning as a prismatic pair. The two links 35 constitute a first coupler and a second coupler of the disclosure, and the two pins 36 constitute a first follower and a second follower of the disclosure. The two pins 36 linearly reciprocate in opposite directions.

The fixing mechanism of the folding mechanism 30 includes the base end-side arm 21, the bushings 31A-1 of the inner clevises 31-1, the handle 34, the links 35, the pins 36, the first joints 37, and the second joints 38.

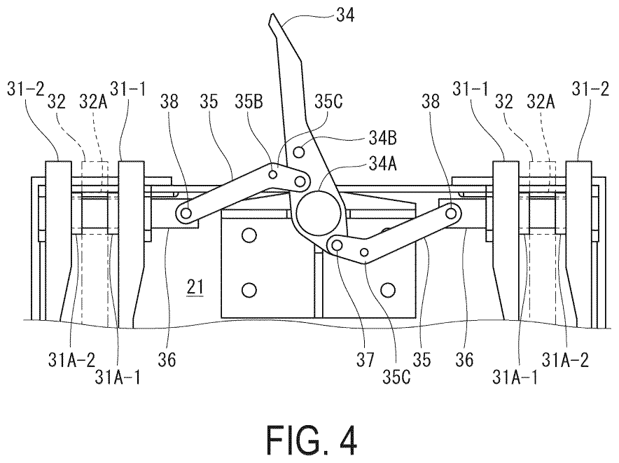

FIG. 4 illustrates a position that is between the fixing position and the releasing position and is a halfway position of the pivoting movement of the handle 34 between approximately a 12 o'clock position and 11 o'clock. At this time, the pins 36 are inserted into the bushings 32A of the lugs 32 and the bushings 31A-2 of the outer clevises 31-2.

When the handle 34 moves from the releasing position to the fixing position, the pins 36 linearly move outward from the center of the rotor shaft 34A. When the handle 34 moves from the fixing position to the releasing position, conversely, the pins 36 linearly move toward the center of the rotor shaft 34A.

Note that, since the handle 34 including the lever portion that can be gripped by the operator is provided, the fixing and releasing operations can be easily performed by a single action by the operator without newly providing a drive source for rotating the rotor shaft 34A.

FIG. 5 illustrates a state in which the pins 36 of the fixing mechanism are held at the fixing position. At this time, the handle 34 is located at approximately a 9 o'clock position, and the tip end portion of the handle 34 is in contact with the inner clevis 31-1. By bringing the tip end portion of the handle 34 into contact with the inner clevis 31-1, the range of the pivoting movement of the handle 34 can be restricted, and the operator can easily determine that the handle 34 is at the fixing position. At this time, the reverse rotation of the rotor shaft 34A is restricted.

With the pins 36 at the fixing position, the rotation centers of the rotor shaft 34A functioning as a revolute pair, the first joints 37, and the second joints 38 are aligned on a straight line indicated by a dash-dotted line DC in the linear movement direction of the pins 36. That is, the fixing position of the fixing mechanism corresponds to the top dead center among dead center positions in the slider crank mechanism, and even when an external force in a direction in which the pins 36 are pulled out from the bushings 31A-1 and 31A-2 of the clevises 31-1 and 31-2 and the bushings 32A of the lugs 32 is applied to the pins 36 at the fixing position, a force for pivoting the handle 34 is not generated. Therefore, even when an external force in the linear movement direction is applied to the pins 36 having reached the fixing position, the pins 36 can be prevented from being released from the fixed state.

After the handle 34 reaches the fixing position, the pins 36 are not pulled out from the bushings 31A of the clevises 31 and the bushings 32A of the lugs 32 unless a rotational force for shifting the rotation centers of the revolute pair aligned in a straight line is applied to the handle 34 or the links 35. That is, even when vibration occurs while the multicopter 1 is flying, the fixing mechanism having reached the fixing position is not easily released from the fixed state.

### Fixing Method and Releasing Method for Arm 20: See FIGS. 3, 4, and 5

A fixing method and a releasing method for the arm 20 will be described with reference to FIGS. 3 to 5. The fixing method will be described in the order of FIGS. 3, 4, and 5, and the releasing method will be described in the order of FIGS. 5, 4, and 3.

First, the fixing method will be described.

As illustrated in FIG. 3, the pins 36 at the releasing position are pulled out from the bushings 31A-2 of the outer clevises 31-2 and held inside the bushings 31A-1 of the inner clevises 31-1. Although the lugs 32 are not illustrated in FIG. 3, the pins 36 are also pulled out from the bushings 32A of the lugs 32.

As illustrated in FIG. 4, in order to move the pins 36 from the releasing position to the fixing position, the tip end-side arm 22 is moved to the unfolded position, and then the handle 34 is moved counterclockwise by the operator. At this time, the rotor shaft 34A performs reverse rotation. When the handle 34 is moved counterclockwise by the operator, the pins 36 start moving linearly from the inner clevises 31-1 toward the outer clevises 31-2. When the pins 36 move linearly, the pins 36 are inserted into the bushings 32A of the lugs 32 each of which is sandwiched between the inner clevis 31-1 and the outer clevis 31-2, and then the pins 36 are inserted into the bushings 31A of the outer clevises 31 2. Sandwiching each of the lugs 32 between the two clevises 31-1 and 31-2 and causing the bushings 31A-1, 31A-2, and 32A to be locked at once by the pins 36 can improve the strength and the characteristics against vibration as compared with causing one clevis and one lug to be locked by a pin.

As illustrated in FIG. 5, the pins 36 at the fixing position are inserted and held in the bushings 31A-1 of the inner clevises 31-1, the bushings 32A of the lugs 32, and the bushings 31A-2 of the outer clevises 31-2, thereby locking the base end-side arm 21 and the tip end-side arm 22.

Upon reaching the fixing position, the handle 34 comes into contact with the inner clevis 31-1. The handle 34 comes into contact with the inner clevis 31-1, causing the pins 36 to reach the fixing position. The pins 36 are held at the fixing position, causing the locked state of the base end-side arm 21 and the tip end-side arm 22 to be maintained.

Next, the releasing method will be described.

As illustrated in FIG. 5, the pins 36 are held at the fixing position. To move the pins 36 held at the fixing position to the releasing position, the handle 34 is caused to pivot clockwise. A rotational force in the forward rotation direction is applied to the rotor shaft 34A.

As illustrated in FIG. 4, when the handle 34 is pivoted clockwise by the operator, the pins 36 start moving linearly from the outer clevises 31-2 toward the inner clevises 31-1. When the pins 36 move linearly, the pins 36 are pulled out from the bushings 31A-2 of the outer clevises 31-2. Subsequently, the pins 36 are pulled out from the bushings 32A of the lugs 32.

As illustrated in FIG. 3, the pins 36 having reached the releasing position are pulled out from the bushings 32A of the lugs 32, allowing the tip end-side arm 22 provided with the lugs 32 to pivot downward about the hinge pins 33. The base end-side arm 21 and the tip end-side arm 22 are released from the locked state by the pins 36.

### EFFECTS

The multicopter 1 described above exerts the following effects.

### First Effect

The multicopter 1 includes the folding mechanism 30, and thus is capable of fixing or releasing the arm 20 by a single action after moving the tip end-side arm 22 of the arm 20 to the unfolded position.

### Second Effect

In the multicopter 1, sandwiching each of the lugs 32 between the two clevises 31-1 and 31-2 and causing the bushings 31A-1, 31A-2, and 32A to be locked at once by the pins 36 allows the strength and the characteristics against vibration to be improved as compared with causing one clevis and one lug to be locked by a pin.

### Third Effect

In the multicopter 1, making the fixing position of each of the pins 36 a position of the top dead center of the slider crank mechanism can prevent, even when a force for pulling out the pins 36 from the bushings 31A-1, 31A-2, and 32A is applied to the pins 36, the pins 36 from being pulled out from the bushings 31A-1, 31A-2, and 32A.

### Fourth Effect

The multicopter 1 has the folding mechanism that flips upward the tip end-side arm 22, and the handle 34 located at a position corresponding to the fixing position of the pins 36 is brought into contact with the inner clevis 31-1. This can prevent the pins 36 from generating a force at the handle 34 in a direction in which the pins 36 are pulled out from the bushings 31A-1, 31A-2, and 32A due to the gravity or the vibration of the multicopter 1 itself.

### Fifth Effect

In the multicopter 1, the pins 36 are provided at symmetrical positions with respect to the rotor shaft 34A of the handle 34, and the base end-side arm 21 and the tip end-side arm 22 are reliably locked by the two pins 36, allowing the mechanical strength of the arm 20 at the unfolded position to be improved.

### Sixth Effect

Since the multicopter 1 includes the handle 34, the fixing and releasing operations can be easily performed by a single action by the operator without newly providing a drive source for rotating the rotor shaft 34A.

In addition to the above, the configurations described in the above-described embodiment can be selected or omitted or can be changed to other configurations as necessary.

In the present embodiment, the rotor shaft 34A rotates along with the pivoting movement of the handle 34 and is rotatably supported by the base end-side arm 21, but is not limited thereto. For example, the rotor shaft 34A may be fixed to and supported by the base end-side arm 21 and may rotatably support the handle 34. In this embodiment, the arm 20 can be fixed or released by a single action by the counterclockwise or clockwise operation of the handle 34 by the operator.

### SUPPLEMENTARY NOTES

For the multicopter 1 according to the embodiment described above, the configurations below are understood.

### Supplementary Note 1

A multicopter (1) according to the disclosure including:
a first link (31) and a second link (32), one of the first link and the second link being pivotable relative to the other of the first link and the second link between an open position and a closed position about a pin joint; and
a fixing mechanism (21, 31A-1, 34, 35, 36) configured to hold the first link (31) and the second link (32) at the closed position, wherein
the fixing mechanism (21, 31A-1, 34, 35, 36)
is a slider crank mechanism and includes
a follower (36) that can be reciprocated between a fixing position at which the first link (31) and the second link (32) can be held at the closed position and a releasing position at which the first link (31) and the second link (32) can be released from the closed position by forward rotation or reverse rotation of a rotor shaft (34A),
a driver (34) pivoted by the forward rotation or the reverse rotation of the rotor shaft (34A),
a coupler (35) rotatably coupled to the follower (36) and rotatably coupled to the driver (34), and
a fixed link (21, 31) rotatably coupled to the driver (34) and slidably coupled to the follower (36), and
the follower (36) held at the fixing position locks the first link (36) and the second link (32).

### Supplementary Note 2

The multicopter (1) according to Supplementary Note 1, wherein the follower (36) can be reciprocated in a direction in which a center axis of rotation of the pin joint extends.

### Supplementary Note 3

The multicopter (1) according to Supplementary Note 1 or Supplementary Note 2, wherein
the first link (31) is composed of a first A link (31-1) and a first B link (31-2),
the first A link (31-1), the first B link (31-2), and the second link (32) are arranged in a direction in which the center axis of rotation of the pin joint extends, and
the second link (32) is sandwiched between the first A link (31-1) and the first B link (31-2).

### Supplementary Note 4

The multicopter (1) according to any one of Supplementary Note 1 to Supplementary Note 3, wherein the fixing position corresponds to a dead center position of the slider crank mechanism.

### Supplementary Note 5

The multicopter (1) according to any one of Supplementary Note 1 to Supplementary Note 4, including:
a base end-side arm (21) connected to a fuselage of the multicopter; and
a tip end-side arm (22) pivotable relative to the base end-side arm (21) by the pin joint, wherein
the fixing mechanism (21, 31A-1, 34, 35, 36) and the first link (31) are provided at one of the base end-side arm (21) and the tip end-side arm (22),
the second link (32) is provided at the other of the base end-side arm (21) and the tip end-side arm (22),
the closed position is an unfolded position at which the tip end-side arm (22) is unfolded and the multicopter is flyable, and
the open position is a folded position at which the tip end-side arm (22) is folded about the pin joint.

### Supplementary Note 6

The multicopter (1) according to any one of Supplementary Note 1 to Supplementary Note 5, wherein
the follower (36) is composed of a first follower and a second follower provided at symmetrical positions with respect to the rotor shaft (34A),
the coupler (35) is composed of a first coupler rotatably coupled to the first follower and a second coupler rotatably coupled to the second follower, and
the first follower and the second follower can be reciprocated between the fixing position and the releasing position by moving in mutually opposite directions.

### Supplementary Note 7

The multicopter (1) according to any one of Supplementary Note 1 to Supplementary Note 6, wherein when the driver (34) reaches the fixing position by the forward rotation or the reverse rotation of the rotor shaft (34A), the forward rotation or the reverse rotation of the rotor shaft (34A) is restricted.

### Supplementary Note 8

The multicopter (1) according to Supplementary Note 7, wherein the driver (34) comes in contact with the first link (31) or the second link (32), and the forward rotation or the reverse rotation of the rotor shaft (34A) is restricted.

### Supplementary Note 9

The multicopter (1) according to any one of Supplementary Note 5 to Supplementary Note 8, wherein the tip end-side arm (22) is flipped upward about the pin joint and reaches the unfolded position.

### Supplementary Note 10

A fixing mechanism (21, 31A-1, 34, 35, 36) according to the disclosure for holding a tip end-side arm (22) attached to a base end-side arm (21) connected to a fuselage of a multicopter at an unfolded position at which a multicopter is flyable, the fixing mechanism (21, 31A-1, 34, 35, 36) including:
a follower (36) that can be reciprocated between a fixing position and a releasing position by forward rotation or reverse rotation of a rotor shaft (34A);
a driver (34) pivoted by the forward rotation or the reverse rotation of the rotor shaft (34A);
a coupler (35) rotatably coupled to the follower (36) and rotatably coupled to the driver (34); and
a fixed link (21, 31) rotatably coupled to the driver (34) and slidably coupled to the follower (36), wherein
the follower (36) held at the fixing position locks the base end-side arm (21) and the tip end-side arm (22).

### Supplementary Note 11

A method according to the disclosure for fixing a tip end-side arm (22) pin-joined to a base end-side arm (21) connected to a fuselage of a multicopter and provided with a rotor at an unfolded position at which the tip end-side arm (22) is unfolded and the multicopter is flyable or for releasing the tip end-side arm (22) from the unfolded position, the method including:
by applying a rotational force in one direction of a forward rotation or a reverse rotation to a fixing mechanism as a slider crank mechanism after the tip end-side arm (22) reaches the unfolded position, causing a follower (36) of a fixing mechanism to linearly move toward one side and causing the base end-side arm (21) and the tip end-side arm (22) to be locked to the follower (36); or
by applying a rotational force in the other direction of the forward rotation or the reverse rotation to the fixing mechanism, causing the follower (36) of the fixing mechanism to linearly move toward the other side and releasing a locked state by the follower (36).

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A multicopter, comprising:
a first link and a second link, one of the first link and the second link being configured to be pivotable relative to the other of the first link and the second link between an open position and a closed position about a pin joint; and
a fixing mechanism configured to hold the first link and the second link at the closed position, wherein
the fixing mechanism is a slider crank mechanism and comprises
a follower that can be reciprocated between a fixing position at which the first link and the second link can be held at the closed position and a releasing position at which the first link and the second link can be released from the closed position by forward rotation or reverse rotation of a rotor shaft,
a driver pivoted by the forward rotation or the reverse rotation of the rotor shaft,
a coupler rotatably coupled to the follower and rotatably coupled to the driver, and
a fixed link rotatably coupled to the driver and slidably coupled to the follower, and
the follower held at the fixing position locks the first link and the second link.

2. The multicopter according to claim 1, wherein the follower can be reciprocated in a direction in which a center axis of rotation of the pin joint extends.

3. The multicopter according to claim 1, wherein
the first link is composed of a first A link and a first B link,
the first A link, the first B link, and the second link are arranged in a direction in which the center axis of rotation of the pin joint extends, and
the second link is sandwiched between the first A link and the first B link.

4. The multicopter according to claim 1, wherein the fixing position corresponds to a dead center position of the slider crank mechanism.

5. The multicopter according to claim 1, comprising:
a base end-side arm connected to a fuselage of the multicopter; and
a tip end-side arm pivotable relative to the base end-side arm by the pin joint, wherein
the fixing mechanism and the first link are provided at one of the base end-side arm and the tip end-side arm,
the second link is provided at the other of the base end-side arm and the tip end-side arm,
the closed position is an unfolded position at which the tip end-side arm is unfolded and the multicopter is flyable, and
the open position is a folded position at which the tip end-side arm is folded about the pin joint.

6. The multicopter according to claim 1, wherein
the follower is composed of a first follower and a second follower provided at symmetrical positions with respect to the rotor shaft,
the coupler is composed of a first coupler rotatably coupled to the first follower and a second coupler rotatably coupled to the second follower, and
the first follower and the second follower can be reciprocated between the fixing position and the releasing position by moving in mutually opposite directions.

7. The multicopter according to claim 2, wherein when the driver reaches the fixing position by the forward rotation or the reverse rotation of the rotor shaft, the forward rotation or the reverse rotation of the rotor shaft is restricted.

8. The multicopter according to claim 7, wherein
the driver comes in contact with the first link or the second link, and
the forward rotation or the reverse rotation of the rotor shaft is restricted.

9. The multicopter according to claim 5, wherein the tip end-side arm is flipped upward about the pin joint and reaches the unfolded position.

10. A fixing mechanism for holding a tip end-side arm attached to a base end-side arm connected to a fuselage of a multicopter at an unfolded position at which the multicopter is flyable, the fixing mechanism comprising:
a follower that can be reciprocated between a fixing position and a releasing position by forward rotation or reverse rotation of a rotor shaft;
a driver pivoted by the forward rotation or the reverse rotation of the rotor shaft;
a coupler rotatably coupled to the follower and rotatably coupled to the driver; and
a fixed link rotatably coupled to the driver and slidably coupled to the follower, wherein
the follower held at the fixing position locks the base end-side arm and the tip end-side arm.

11. A method for fixing a tip end-side arm pin-joined to a base end-side arm connected to a fuselage of a multicopter and provided with a rotor at an unfolded position at which the tip end-side arm is unfolded and the multicopter is flyable or for releasing the tip end-side arm from the unfolded position, the method comprising:
by applying a rotational force in one direction of a forward rotation or a reverse rotation to a fixing mechanism as a slider crank mechanism after the tip end-side arm reaches the unfolded position, causing a follower of the fixing mechanism to linearly move toward one side and causing the base end-side arm and the tip end-side arm to be locked to the follower; or
by applying a rotational force in the other direction of the forward rotation or the reverse rotation to the fixing mechanism, causing the follower of the fixing mechanism to linearly move toward the other side and releasing a locked state by the follower.
